(19) United States
(12) Patent Application Publication
(10) Pub. No.: US 2019/0302701 A1
(43) Pub. Date: Oct. 3, 2019

(54) TIME KEEPING DEVICE HAVING PARTICULATE MATTER MIXED IN FLUID MEDIUM SUITABLE FOR CHILD DISCIPLINE

(71) Applicant: Mariah White, Deerfield Beach, FL (US)

(72) Inventor: Mariah White, Deerfield Beach, FL (US)

(21) Appl. No.: 15/938,506

(22) Filed: Mar. 28, 2018

(51) Int. Cl. G04F 1/08

(52) U.S. Cl. CPC G04F 1/08

(57) ABSTRACT

A time keeping device suitable for use as a time-out timer includes opposing flat ends on either of which the device can be stood, and includes a body having a wall or walls that are transparent or have a transparent portion to allow viewing the interior of the body. A mixture of a fluid medium and a mass of a particulate matter are disposed inside the body, viewable through the transparent wall. The fluid medium and the amount of the particulate matter are selected so that, after being agitated to distribute the particles of the particulate matter throughout the fluid medium, the particles accumulate by settling while the device is at rest to a certain level in a preselected period of time.

### FIELD OF THE INVENTION

The present invention relates generally to timing devices, and more particularly to timing devices that utilize gravity to move material over a period of time in a visible encasement.

### BACKGROUND OF THE INVENTION

Not everyone can tell time by looking at a clock, and this is especially true of small children that have not yet learned how to read an analog clock, and who do not have a good enough appreciation of time to understand the passing of time on digital clocks. Yet in many situations it is important for a child to observe a period of time. Time periods are used in games, to measure how long an activity is to last, and sometimes for disciplinary purposes, such as taking a “time-out.”

A time-out is a short period of time where a child must sit quietly as a consequence for undesirable behavior. The time-out time period allows the child to take a break from and, optimally, redesign their behavior. Typically a time-out involves the child sitting alone, quietly, in a particular location, for a period of time. A common time-out rule of to use one minute per year of age of the child. The child is usually told when the time-out period is over. There are several problems with this approach, however. For one, young children do not have a good concept of time, and are unable to judge time duration. If the adult acts as the time keeper, then the child sits with no way to judge the passage of time. This also requires the adult to intervene at the end of the time-out period, rather than allowing the child to discipline themselves by observing the time-out period until the end, without having to be told when the time-out period is over by an adult. Requiring a child to go from disruptive behavior to sitting quietly for what, to the child, is an indeterminate time period, is not always reasonable.

Sometime an hourglass or similar time keeping device can be used to visually indicate the passage of time, and help teach children an intuitive sense of the passage of time. While the hourglass is effective, it is rather simple, and does not take advantage of time to stimulate other thinking in a child beyond simply watching the proportions of material change from the upper chamber to the lower chamber. It also lacks interaction as it operates by simply turning the hourglass over.

Accordingly, there is a need for an enhanced visual time measuring device that can be used to aid in the development of self-discipline when giving young children time-outs.

### SUMMARY OF THE INVENTION

The invention provides a time keeping device that overcomes the hereinafore-mentioned disadvantages of the heretofore-known devices and methods of this general type and that uses a mixture of a particulate matter in a fluid medium that, after being agitated into a distributed state, the particles in the particulate matter begin settling over time. An can indicia indicate when the settled amount of particles corresponds to a preselected period of time. The viscosity of the fluid medium and the amount of the particulate matter are selected such that a proportion of the particulate matter settles in the selected amount of time. As the particulate matter is settling, it creates a visually interesting effect in the fluid medium that can stimulate a child's attention and thoughts while observing the time keeping device.

With the foregoing and other objects in view, there is provided, in accordance with the invention, a time keeping device for visually indicating a passage of a selected period of time. The time keeping device includes a case having an internal volume, a transparent wall, and a first end and a second end opposing the first end. Both the first and second ends have a respective exterior surface on which the time keeping device can stand. The time keeping device can further include a fluid disposed in, and substantially filling the internal volume. The time keeping device can further include a particulate matter disposed in the fluid in an amount selected to have a selected settling time in the fluid equal to the selected period of time. The selected settling time being the time for the particulate matter to reach a settled state from a distributed state upon the time keeping device being left undisturbed after being agitated to distribute the particulate matter in the fluid to the distributed state. The time keeping device can further include an indicia positioned to indicate the passage of the selected settling time upon the particulate matter reaching the settled state.

In accordance with another embodiment, the case is cylindrical.

In accordance with another embodiment, the fluid comprises a solution of water and a thickening agent dissolved in the water, and wherein the fluid has a viscosity that is higher than water.

In accordance with another embodiment, the thickening agent comprises polyvinyl acetate.

In accordance with another embodiment, the fluid is transparent.

In accordance with another embodiment, the particulate matter is comprised of flat particles, each flat particle having a surface area in a range of 0.002 to 0.25 square inches, and comprising a reflecting layer of a material selected from a group consisting of aluminum, titanium dioxide, iron oxide, and bismuth oxychloride.

In accordance with another embodiment, the indicia comprises at least one mark on an exterior surface of the case at a height on the exterior surface of the case corresponding to a height of settled particulate matter at the selected settling time.

In accordance with another embodiment, the indicia comprises at least one mark on an interior surface of the transparent wall at a height on the transparent wall corresponding to a height of settled particulate matter at the selected settling time.

In accordance with another embodiment, the indicia is disposed inside the sealed internal volume, and which is obscured from view when the particulate matter is in the distributed state, and which becomes visible upon the particulate matter settling into the settled state.

In accordance with another embodiment, the time keeping device includes a light circuit including a light emitting source and a timer, wherein the timer is triggered by movement of the time keeping device and is configured to commence timing upon the time keeping device remaining still, wherein the timer is configured to time a period of time equal to the selected settling time and change a light output state of the light emitting device.

In accordance with another embodiment, the fluid comprises 5.0 to 15.0 parts water to 1.0 part combined water soluble polymeric solute and solid particulate matter.

Although the invention is illustrated and described herein as embodied in a [TITLE], it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

“In the description of the embodiments of the present invention, unless otherwise specified, azimuth or positional relationships indicated by terms such as “up”, “down”, “left”, “right”, “inside”, “outside”, “front”, “back”, “head”, “tail” and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first”, “second”, “third” and so on are only used for descriptive purposes, and cannot be construed as indicating or implying relative importance.

In the description of the embodiments of the present invention, it should be noted that, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the time keeping device, from one end to the other end. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system. Those skilled in the art can understand the specific meanings of the above-mentioned terms in the embodiments of the present invention according to the specific circumstances

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective view of a time-out timer, in accordance with some embodiments;

FIG. 2 is a side elevational view of a time-out timer in a fully settled state, in accordance with some embodiments;

FIG. 3 shows one method of agitating a time-out timer to commence a timing period, in accordance with some embodiments;

FIG. 4 shows one method of agitating a time-out timer to commence a timing period, in accordance with some embodiments;

FIG. 5 shows a side elevational view of a time-out timer at rest immediately after agitation and upon commencement of a timing period, in accordance with some embodiments;

FIG. 6 shows a side elevational view of a time out timer at rest during a timing period at a first time prior to the end of the timing period, in accordance with some embodiments;

FIG. 7 shows a side elevational view of a time out timer at rest during a timing period at a second time prior to the end of the timing period, in accordance with some embodiments;

FIG. 8 shows a side elevational view of a time out timer at rest during a timing period at the end of the timing period, in accordance with some embodiments;

FIG. 9 shows a comparison diagram of two time-out timers designed to time different timing periods, in accordance with some embodiments;

FIG. 10 show a perspective view of a time-out timer utilizing an internal feature for marking the end of the timing period, in accordance with some embodiments;

FIG. 11 shows a partial side view of one end of a time-out timer having audio and visual elements to enhance sense stimulation during a timing period and to further mark an end of the timing period, in accordance with some embodiments;

FIG. 12 is a schematic circuit block diagram of a circuitry configured to enhance sense stimulation during a timing period and to further mark an end of the timing period, in accordance with some embodiments; and

FIG. 13 is a flowchart diagram of a method of determining and mixing the fluid and particulate matter to achieve a desired timing period in a time-out timer, in accordance with some embodiments.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient time keeping device suitable for use in child discipline to encourage positive behavior, teach an intuitive sense of time, and provide a visually interesting item on which a child can focus their attention. Embodiments disclosed wherein include a time keeping device for visually indicating a passage of a selected period of time. The time keeping device includes a case having an internal volume, a transparent wall, and a first end and a second end opposing the first end. Both the first and second ends have a respective exterior surface on which the time keeping device can stand. The time keeping device can further include a fluid disposed in, and substantially filling the internal volume. The time keeping device can further include a particulate matter disposed in the fluid in an amount selected to have a selected settling time in the fluid equal to the selected period of time. The selected settling time being the time for the particulate matter to reach a settled state from a distributed state upon the time keeping device being left undisturbed after being agitated to distribute the particulate matter in the fluid to the distributed state. The time keeping device can further include an indicia positioned to indicate the passage of the selected settling time upon the particulate matter reaching the settled state.

FIG. 1 is a perspective view of a time-out timer 100, in accordance with some embodiments. The time-out timer 100 is used for timing a selected period of time by providing a visually noticeable change over time. Specifically, a particulate matter (e.g. a plurality of particles) are provided in a fluid medium inside the time-out timer 100, in a sealed internal volume of the interior 112, which can be seen through the wall 102 or a transparent portion of a wall 102, which is, or forms part of a container body. The time-out timer 100 is initially agitated to distribute the particles of the particulate matter throughout the fluid, and upon setting the time-out timer 100 on a surface, without further disturbance or agitation, the particulate matter will begin settling at the bottom of the time-out timer 100. The viscosity of the fluid medium and the amount of particulate matter are selected based on the volume of the interior 112 of the time-out timer 100 so that the particulate matter settles to a certain level or height, demarcated by timing indicia such as lines 108, 110, in a desired time (e.g. the timing period).

The time-out timer 100 is shown here in a substantially cylindrical embodiments having a first end 104 and a second end 106 at opposite ends of a transparent cylindrical wall 102. The first and second ends have respective exterior surfaces on which the time-out timer can be stood at rest. The first and second ends 104, 106 are either a top or a bottom end depending on which end is set on a surface. That is, the time-out timer 100 is designed to work the same no matter which end 104, 106 is at the top and bottom. For that reason, there can be multiple indicia of time passage, such as lines 108, 110, and 114. For example, lines 108 and 110 can correspond, based on the fluid composition and amount of particulate matter in the time-out timer 100, to a time period of five minutes. Thus, when second end 106 is the end placed on a surface to commence timing, then line 110 is used to determine when the five minutes have elapsed. When end 104 is placed on the surface to start timing, then line 108 indicates when the five minutes have elapsed. In some embodiments other indicia can be present, such as line 114, to mark the passage of a different duration of time than lines 108, 110. For example, line 114 can mark the point at which 4 minutes have elapsed when end 106 is at the bottom.

Since the interior 112 includes a fluid medium, the ends 104, 106 are sealed to the wall 102 to prevent leakage of the fluid medium. The lines 108, 110, 114 can circumscribe the time-out timer 100, defining a plane parallel to the plane defined by the ends 104, 106 at their exterior major surfaces. In some embodiments the lines 108, 110, 114 can be hash marks that do not circumscribe the wall 102. Likewise, the lines 108, 110, 114 can be provided on the exterior surface or the interior surface of the wall 102. Furthermore, the wall 102 can be shaped in other, non-cylindrical shapes, as well. In general, however, the time-out timer is vertically symmetric so that it can be placed on either end. In some embodiments, the lines 108, 110, 114 can all correspond to different timing periods. For example line 108 can correspond to a six minute time period when the time-out timer 100 is stood on first end 104, and line 110 can correspond to a five minute time period when the time-out timer 100 is stood on second end 106.

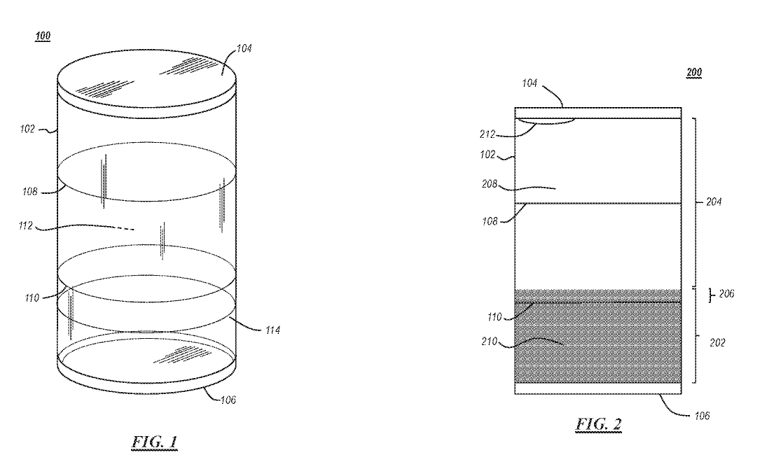

FIG. 2 is a side elevational view 200 of a time-out timer in a fully settled state, in accordance with some embodiments. For the sake of example, the time-out timer shown here can be the same as that shown in FIG. 1, with the reference numeral carried over. However, as shown here, the time-out timer include the fluid medium and particulate matter 210 in the interior volume of the time-out timer, in a completely settled state, as would occur after a long time of being left undisturbed. The particulate matter can be small particles of reflective material, such as that known as “glitter.” Glitter is made of a laminate including, generally, two or more polymeric layers that can be colored, and a reflecting layer. In some embodiments the particulate matter can be comprised of flat particles, with each flat particle having a surface area in a range of 0.002 to 0.25 square inches, and including a reflecting layer of a material selected from a group consisting of aluminum, titanium dioxide, iron oxide, and bismuth oxychloride. The fluid medium can be aqueous-based (e.g. water or solution of water) with a thickening agent, such as, for example, polyvinyl acetate, which is a main ingredient in common white household glue. A coloring agent can be added as well. The use of polyvinyl acetate can produce an opaque fluid. In some embodiments a different fluid medium, such as one based on vegetable oil, can be used to achieve a transparent fluid medium.

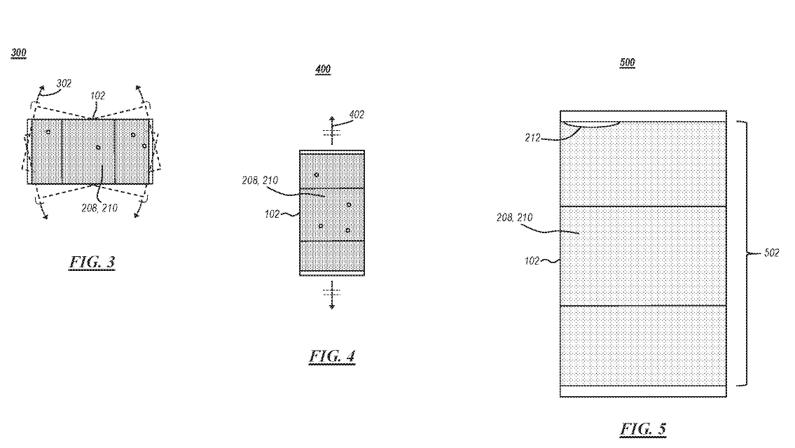

As shown in FIG. 2, the particulate matter 210 is completely settled, and has achieved a height indicated by 202. Which can be higher than line 110 by an amount 206. Thus, after being agitated and stood as shown, the particulate matter will begin settling towards the bottom, which in this example is end 106. As the particulate matter settles over time, the height of the settled particulate matter increases. The fluid medium viscosity and the amount of particulate matter are selected such that, once the height of the settled particulate matter reaches line 110, the approximate desired timing period has elapsed. When that occurs, there will still be some particulate matter distributed in the fluid medium that has not settled. It may take substantially longer than the selected timing period for all of the particulate matter to settle, leaving a region 204 of the fluid medium 208 without any significant amount of particulate matter. A small amount of a gas can be added to produce a bubble 212 to help with agitation. The gas can be, for example, nitrogen to avoid producing any oxidation with the fluid medium 208. FIGS. 3-8 show a progression of usage of a time-out timer from the completely settled state shown in FIG. 2.

FIG. 3 shows one method 300 of agitating a time-out timer to commence a timing period, in accordance with some embodiments. Specifically, the time-out timer can be shaken horizontally, alternating each end up and down, as indicated by arrow 302, for example. That is, a user can pick up the time-out timer from the position shown in FIG. 2, hold the time-out timer about its center, and twist their hand back and forth rapidly to agitate the fluid medium 208 and particulate matter 210. The gas bubble 212 can be distributed into smaller bubbles through the mixture of the fluid medium 208 and the particulate matter 210. Similarly, in FIG. 4, another method 400 of agitating a time-out timer to commence a timing period is shown, in accordance with some embodiments. In FIG. 4, the time-out timer is vertically shaken to distribute the particulate matter 210 throughout the fluid medium 208, as indicated by line 402, for example. Many other methods of shaking the time-out timer are equally useful to distribute the particulate matter. Once the time out timer is sufficiently shaken to distribute the particulate matter 210 throughout the fluid medium 208 substantially uniformly, to a fully distributed state, as shown in FIG. 5. FIG. 5 shows the state of the time-out timer immediately after agitation, where the particulate matter 210 is substantially uniformly distributed throughout the entirely 502 of fluid medium.

FIGS. 6-8 show a sequence of time progression following the state of FIG. 5, where the time-out timer is left undisturbed, in side elevational views of a time-out timer, in accordance with some embodiments. In each of FIGS. 6-8 a clock is shown at various times 602, 702, 802, respectively is shown to indicate the relative passage of time. The clock is shown as a conventional clock having a long hand for minutes and a short hand for hours. From the state of FIG. 5 to the state of FIG. 8, approximately 8 minutes elapses, for the sake of example.

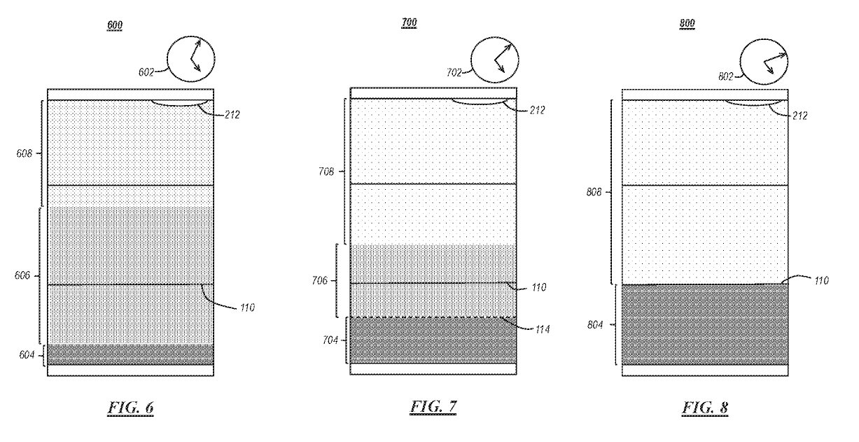

In FIG. 6, there is a region 604 of settled particulate material that is well below line 110. There is a region 606 of settling particulate matter where the density of particulate matter is not as high as in region 604. In region 608 the particulate matter is still distributed in a density that is lower than in region 606. In FIG. 7, the region 704 of settled particulate matter has increased; there is still more settling particulate matter in region 706, and in region 708 there can be very little particulate matter. In some embodiments where an additional indicia line 114 is included, the height of the region 704 can indicate the elapse of a period of time corresponding to line 114 has occurred. In FIG. 8, the height of the settled region 804 of the particulate matter has reached line 110, indicating that the period of time corresponding to line 110 has elapsed since FIG. 5. Region 808 will have very little particulate matter left in it, but there is still some there. It will be appreciated by skilled artisans that while hard borders are shown between regions in FIGS. 6-8 for the sake of example, in reality only the height of the settled particulate matter in regions 604, 704, and 804 evidences a defined level, visually. Above that height, the particulate matter can be distributed in a gradually decreasing density going upward from the top of the settled particulate matter.

One use for the time-out timer is in child discipline. When a child does something that merits a disciplinary action, it is common to have the child take a “time out,” which is a period of time where the child must, for example, sit in a chair for a period of time. Many child rearing experts suggest time out period of one minute per year of age of the child. So a four year old would have a time out period of four minutes, while a six year old child would have a six minute time out period. Accordingly, there needs to be a way to time such different periods as the child grows, and when there are children of differing ages. That can be accomplished by having different indicia (e.g. lines 110, 114) corresponding to different times, or by having different time-out timers configured to reach their settling time at different durations.

A simple method of using the time-out timer is, upon the child engaging in negative or disruptive behavior, escort the child away from the situation to a time-out location that will be quiet. Give the child the time-out timer and have the child shake the time-out timer to sufficiently agitate the contents of the time-out timer and until the child wants to stop shaking the time-out timer. The act of shaking the time-out timer acts as a physical outlet for the child, and can allow the child to deescalate their emotional state. Once the child is ready to commence the time-out time period, the child can then set the time keeping device on a nearby surface and watch as the contents move, swirl, and settle. The adult should move away from the child to encourage self-discipline and allow the child to observe the time keeping device or otherwise settle on their own. In some cases the adult can allow the child to determine when they are able to behave, which can occur before the end of the time-out time period as indicated by the time keeping device. In some cases there may be a need for having different time keeping devices for different time periods.

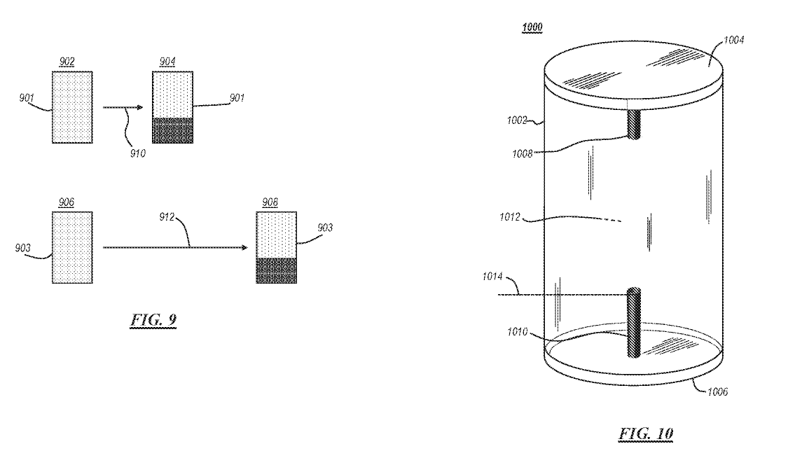

FIG. 9 shows a comparison diagram of two time-out timers designed to time different timing periods, in accordance with some embodiments. In some embodiments, different time-out timers 901, 903 can be constructed to have different timing periods. Time-out timer 901 goes from the distributed state 902 to a mostly settled state 904 in a first period of time, represented by the length of arrow 910. Time-out timer 903 can be configured to take a longer time, as indicated by the relative length of line 912, to go from a distributed state 906 to a mostly settled state 908 where the height of the settled particulate matter reaches an indicia corresponding to the time period represented by line 912. Thus, different time-out timers can be used for timing different periods. In some embodiments the time-out timer periods can range from two to ten minutes.

FIG. 10 show a perspective view of a time-out timer 1000 utilizing an internal feature for marking the end of the timing period, in accordance with some embodiments. The time-out timer 1000 is similar to that of FIG. 1, and has a transparent wall 1002 or wall portion, a first end 1004 and a second end 1006. The interior volume 1012 is to be filled with a mixture of a fluid medium and a volume of particulate matter (not shown). But rather than having an indicia on the wall 1002 to indicate the lapse of the time-out period, the time-out timer 1002 includes internal feature 1008, 1010 that are used to determine the passage of a time-out time period. For example, internal feature 1010 can be something attached to the interior surface of the second end 1006 that protrudes into the interior volume 1012, to a height 1014. The fluid medium for this arrangement needs to be transparent enough to see the features 1008, 1010. When the time-out timer 1000 is agitated to distribute the particulate matter throughout the fluid medium, and then set in rest, the particulate matter will settle at the bottom (i.e. at the second end 1006 in this example). The height 1014 is selected so that, as the particulate matter settles, the settled particulate matter reaches the height at the time-out time period. The features 1008, 1010 can have different heights corresponding to different time period durations. In some embodiments the features 1008, 1010 can have indicia marked at different heights to correspond to different time period durations. In some embodiments the features 1008, 1010, shown here for exemplary purposes as simple rods, can depict objects, characters, animals, etc. In some embodiments there can be multiple features on each end 1004, 1006, such as, for example two or more rods of different heights, each corresponding to the a different time out time duration. In some embodiments, the internal features can be obscured from view, and revealed as the particulate matter settles to indicate the passage of the time period.

FIG. 11 shows a partial side view of one end of a time-out timer 1100 having audio and visual elements to enhance sense stimulation during a timing period and to further mark an end of the timing period, in accordance with some embodiments. The time-out timer 1100 has a first end 1102 and a wall 1104 that is transparent or has a transparent portion to allow a person to see into the interior volume of the time-out timer. In some embodiments such as is shown in FIG. 11, circuitry can be used to enhance the time-out time period such as by emitting a sound at the end of the time-out time period, or enable a light effect. Accordingly, the first end 1106 can include, for example, one or more speakers or speaker ports 1106, and one or more light elements 1108 such as light emitting diodes (LEDs). The LEDs can be enabled, disabled, or change states (e.g. color) when the time out period elapses. The LEDs 1108 can be mounted inside the interior volume of the time-out timer, as shown, close to the wall 1104, under the wall so as to project light up inside the transparent wall 1104, or outside on the end 1102, or combinations thereof. In some embodiments the light elements can include ultraviolet light sources to create a glowing effect in phosphor material in the fluid (e.g. in the glitter). These audio and visual elements can be used in conjunction with the particulate matter and fluid medium inside the time-out timer 1100. That is, the circuitry can be programmed to activate a sound or light effects at approximately the same time as the settled particulate matter reaches a certain height that has been selected to correspond to the time-out duration. The time-out timer 1100 can also include a connector 1110, such as a universal serial bus (USB) connector to charge a battery inside the end 1102 that powers the circuitry. A small LED 1112 can be used to indicate charging status.

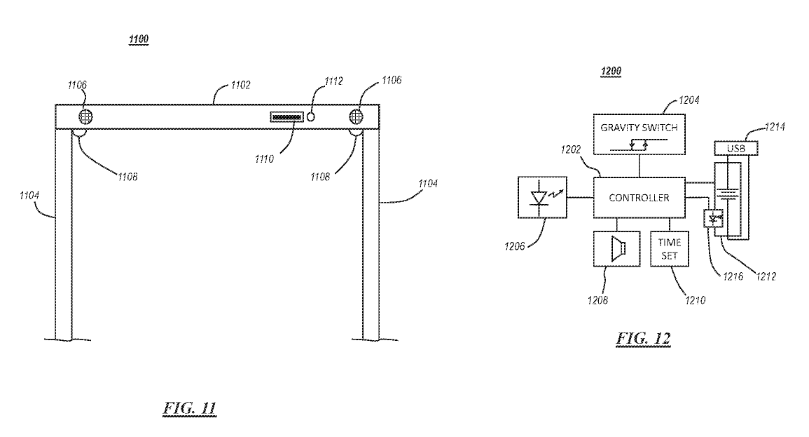

FIG. 12 is a schematic circuit block diagram of a circuitry 1200 configured to enhance sense stimulation during a timing period and to further mark an end of the timing period, in accordance with some embodiments. The circuitry 1200 can be equivalent to circuitry used in the end 1102 of FIG. 11 in some embodiments. A controller circuit 1202 can include a timing circuit that is responsive to a gravity switch 1204. The timing circuit is configured to time the time-out timer period, and can include, in some embodiments, a microcontroller and memory for instruction code that is executed by the microprocessor for timing purposes. In some embodiments the controller circuit 1202 can include one or more 555 monostable multivibrator timer integrated circuits. The gravity switch 1204 can include, in some embodiments, and mercury switch, and once it settles into a given state when the time-out timer is left to rest, the controller circuit 1202 commences timing the time-out period. In some embodiments, the gravity switch can be a micro electromechanical switch (MEMS) circuit, such as those used in accelerometers to sense motion. When the time-out timer stops moving (e.g. after agitation), the timing operation commences. Movement, as sensed by the gravity switch 1204, can trigger the controller circuit to look for the time-out timer to be set to rest (e.g. agitated and then placed at rest). The time period that is timed can be set by a time-set sub-circuit 1210, which can simply be a resistor or resistance whose resistance value (e.g. in Ohms) adjusts the duration of the time period being timed by the controller circuit 1202, as is well known. In some embodiments the time-set sub-circuit can be a dual inline package (DIP) switch array where the configuration of the plurality of switches controls the time period duration that is timed by the controller circuit 1202.

The controller circuit 1202 is operably coupled to one or more illumination sources 1206 and at least one audio or acoustic transducer 1208. The illumination sources 120 can be LEDs or other low power light sources or light circuits, and they can be colored to produce light of different colors. In some embodiments the light output state can be changed upon lapse of the time-out time period. For example, a red LED can be illuminated while the time-out time period is pending, then shut off at the end of the time-out time period when a green LED is turned on. In some embodiments light can be used to enhance the visual appearance of the particulate matter by reflecting off of the reflective material that may be present in some particulate matter, producing a twinkling effect. The acoustic transducer 1208 can be used to provide an audible indication of the lapse of the time-out period, as well as provide sound during the time-out time period, such as playing music, playing beeps or chirps at one minute intervals where a number of beeps corresponds to the number of minutes that have elapsed, and so on. The controller circuit 1202 can be further coupled to a data connector, such as a USB port 1214, to interact with another device. The USB port 1214 can also be used to provide a charge to a battery 1212 used to power the circuitry 1200. A charging LED 1216 can be used to provide an visual indication of the state of charge of the battery 1212, as is well known.

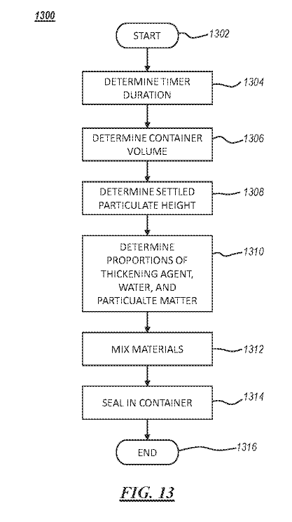

FIG. 13 is a flowchart diagram of a method 1300 of determining and mixing the fluid and particulate matter to achieve a desired timing period in a time-out timer, in accordance with some embodiments. The method starts 1302 by gathering constituents such as the particulate matter to be used, a thickening agent such as polyvinyl acetate (e.g. common household glue) to add to water, or an oil can be used as the fluid medium for transparency. A preliminary step is to select and desired time-out time period in step 1304. Generally, the time-out time period will be a multiple of minutes. In some embodiments the time-out timer can be used to time multiple different time-out time periods by the use of multiple indicia corresponding to the different time-out time periods. In step 1306 the volume of the time-out timer container is determined or otherwise taken into consideration. In step 1308, the amount of particulate matter needed to have a settling time where the settled particulate matter reaches a desired height in the time-out time can be determined, or if already known, measured. In step 1310 the fluid medium is selected to have the necessary viscosity to control the settlement time of the particulate matter from a distributed state after being agitated. The fluid medium can be aqueous or oil based, and can be transparent, translucent, or substantially opaque. The fluid medium can also be colored for a desired color. In step 1312 the particulate matter and fluid medium are put into the interior volume of the time-out timer being assembled, and in step 1314 the time-out timer is sealed. The sealing process can include purging out air with, for example, nitrogen, and leaving a bubble of gas inside the sealed time-out timer to enhance agitation. The bubble of gas can be on the order of one cubic centimeter in total volume. The method 1300 then ends 1316, and a time-out timer is produced that can be used as a time keeping device for visually indicating the passage of a selected period of time.

Several recipes have been developed for different time periods as follows:

### EXAMPLE 1

Five cups of hot water was mixed with four tablespoons of Elmer's™ glitter glue and one half tablespoon of fine glitter. This mixture was tested in both a 500 ml container and an 850 ml container, and resulting in a settling time of five to six minutes. This represents a proportion of 17.8 parts water to 1.0 parts combined polymeric solute and solid particulate matter.

### EXAMPLE 2

Two cups of hot water were mixed with three tablespoons of Elmer's™ glitter glue and 500 ml of the mixture was testing in a 500 ml container, resulting in a settling time of approximately two and a half minutes. This represents a proportion of 10.7 parts water to 1.0 part combined polymeric solute and solid particulate matter.

### EXAMPLE 3

Two cups of hot water were mixed with 4 and a half tablespoons of Xcess™ Styling Gel Sport Hold #10 and one and a half teaspoons of glitter, with the mixture producing a settling time of about three minutes in a 500 ml container. This represents a proportion of 6.4 parts water to 1.0 part combined polymeric solute and solid particulate matter.

In general, it has been found that a mixture of water and water-soluble polymers, such as polyvinyl acetate (glue) or polyvinyl pyrolidone (hair gel), and a glitter (alone or dispersed in a polymeric material) can mixed in proportions to create a desired settling time. It has also been found that water-soluble paints can be used to color to the water. Some water-soluble paints include glitter, similar to that of craft glues. Preferred proportions of the contents of a time keeping device as disclosed can be in the range of 5.0 to 15.0 parts water to 1.0 part combined water-soluble polymeric solute, coloring agent, and solid particulate matter (e.g. glitter).

A time keeping device has been disclosed that can visually indicate the passage of a period of time. The time keeping device is particularly suited for child discipline, where a child takes a “time out” for the time it takes for the particulate matter in the device to settle to a particular level from a distributed state. The particulate matter is disposed in a fluid medium, the mixture of which is viewable through a transparent wall or wall portion of the device. The time keeping device produces a different, and more interesting visual effect than a simple hourglass timer, and can be enhanced with illumination and audio effects that correspond to the timed period. The time keeping device provides several benefits and advantages over the prior art. For one, at the start of a time-out time period, the child can be asked to shake the disclosed time keeping device to agitate and distribute the materials inside the time keeping device. This is a physical act that engages the child and can act as an outlet as children often deal with frustration by acting out physically. Shaking the time keeping device provides the type of physical activity that can take the edge off of a child's negative emotional state. The movement of the materials inside the time keeping device provide something on which the child can focus, and as the material settles, the child can see progress and develop an intuitive sense of the passage of time. It also gives the child a definite end point, which the child can learn to observe for themselves, rather than having to rely on an adult to tell them when the time-out time period is over, which fosters the development of self-discipline.

What is claimed is:

1. A time keeping device for visually indicating a passage of a selected period of time, comprising:
a case having an internal volume, a transparent wall, and a first end and a second end opposing the first end, both the first and second ends having a respective exterior surface on which the time keeping device can stand;
a fluid disposed in, and filling the internal volume; and
a particulate matter disposed in the fluid in an amount selected to have a selected settling time in the fluid equal to the selected period of time, the selected settling time being a time for the particulate matter to reach a settled state from a distributed state upon the time keeping device being left undisturbed after being agitated to distribute the particulate matter in the fluid to the distributed state.

2. The time keeping device of claim 1, further comprising an indicia positioned to indicate the passage of the selected settling time upon the particulate matter reaching the settled state.

3. The time keeping device of claim 1, wherein the fluid comprises a solution of water and a thickening agent dissolved in the water, and wherein the fluid has a viscosity that is higher than water.

4. The time keeping device of claim 3, wherein the thickening agent comprises polyvinyl acetate.

5. The time keeping device of claim 1, wherein the fluid is transparent.

6. The time keeping device of claim 1, wherein the fluid is not transparent.

7. The time keeping device of claim 1, wherein the particulate matter is comprised of flat particles, each flat particle having a surface area in a range of 0.002 to 0.25 square inches, and comprising at least one reflecting layer of a material selected from a group consisting of aluminum, titanium dioxide, iron oxide, and bismuth oxychloride.

8. The time keeping device of claim 2, wherein the indicia comprises at least one mark on an exterior surface of the case at a height on the exterior surface of the case corresponding to a height of settled particulate matter at the selected settling time.

9. The time keeping device of claim 2, wherein the indicia comprises at least one mark on an interior surface of the transparent wall at a height on the transparent wall corresponding to a height of settled particulate matter at the selected settling time.

10. The time keeping device of claim 2, wherein the indicia is disposed inside the sealed internal volume, and which is obscured from view when the particulate matter is in the distributed state, and which becomes visible upon the particulate matter settling into the settled state.

11. The time keeping device of claim 1, further comprising:
a light circuit including a light emitting source and a timer, wherein the timer is triggered by movement of the time keeping device and is configured to commence timing upon the time keeping device remaining still, wherein the timer is configured to time a period of time equal to the selected settling time and change a light output state of the light emitting device.

12. The time keeping device of claim 1, wherein the fluid comprises 5.0 to 15.0 parts water to 1.0 part combined water soluble polymeric solute and solid particulate matter.

13. A time-out timer for child discipline, comprising:
a container body having a transparent wall and first and second opposing ends, the first and second opposing ends being configured to support the time-out timer in a standing manner, and further having a volume that is sealed;
a fluid disposed in the container body and having a viscosity greater than a viscosity of water;
an amount of light reflective particles disposed in the container body and mixed with the fluid; and
an indicia positioned to indicate when the amount of light reflective particle has reached a settled state
wherein the viscosity of the fluid and the amount of light reflective particles are controlled so that the amount of light reflective particles settlers to a settled state from a distributed state in a preselected time period.

14. The time-out timer of claim 13, wherein the preselected time period is a multiple of minutes in a range of two to ten minutes.

15. The time-out timer of claim 13, wherein the amount of light reflective particles is an amount of glitter.

16. The time-out timer of claim 13, wherein the fluid is a solution of water and polyvinyl acetate.

17. The time-out timer of claim 13, wherein the indicia comprises a first circumferential line around the container body and a second circumferential line around the container body.

18. The time-out timer of claim 13, further comprising at least one of an audio transducer or an illumination source that is activated in correspondence with a lapse of the preselected time period.

19. The time-out timer of claim 13, further comprising a bubble of a gas sealed in the container body with the fluid.

20. The time-out timer of claim 13, wherein the indicia is disposed inside the container body.
